(19) United States
(12) Patent Application Publication
(10) Pub. No.: US 2015/0220156 A1
(43) Pub. Date: Aug. 6, 2015

(54) INTERFACE SYSTEM FOR A COMPUTING DEVICE WITH VISUAL PROXIMITY SENSORS AND A METHOD OF INTERFACING WITH A COMPUTING DEVICE

(71) Applicant: Visual Touchscreens Pty Ltd, Osborne Park (AU)

(72) Inventor: Apolon Ivankovic, Wangara (AU)

(21) Appl. No.: 14/562,576

(22) Filed: Dec. 5, 2014

Related U.S. Application Data
(63) Continuation of application No. PCT/AU2013/000887, filed on Aug. 13, 2013.

(30) Foreign Application Priority Data
Jun. 28, 2012 (AU) 2012902762

(51) Int. Cl. G06F 3/01; G06F 3/041; G06T 7/20

(52) U.S. Cl. CPC G06F 3/017; G06T 7/20; G06F 3/0416

(57) ABSTRACT

An interface system for facilitating human interfacing with a computing device is provided. An input device is arranged to detect touch-based inputs made by an object and to communicate the inputs to the computing device. A position detection system obtains positional information that is indicative of a position of respective portions of the object relative to the input device. A shape recognition system uses the positional information to determine a shape or configuration of the object, compare the determined shape/configuration of the object to a predefined object shape/configuration, and determine whether the shape/configuration of the object is substantially similar to the predefined object shape/configuration. A data storage stores information that is indicative of the predefined object shape or configuration and is arranged to select a touch-based input mode in response to determining that the shape/configuration of the object is substantially similar to the predefined object shape/configuration.

### CROSS-REFERENCES TO RELATED APPLICATIONS

This application is a continuation application of PCT application PCT/AU2013/000887 entitled “An Interface System For A Computing Device With Visual Proximity Sensors And A Method Of Interfacing With A Computing Device,” filed on Aug. 13, 2013, which claims priority to Australian Patent Application No. 2012902762, filed on Jun. 28, 2012, which are herein incorporated by reference in their entirety for all purposes.

### FIELD OF THE INVENTION

The present invention relates to an interface system for a computing device and a method of interfacing with a computing device.

### BACKGROUND OF THE INVENTION

Computer input devices, such as keyboards, can be difficult to use in certain circumstances. For example, if a user cannot, or finds it difficult to, look at the input device when inputting information then the user may find it difficult to enter the information correctly.

Such a situation may arise if the user is incapacitated and is required to lie flat on their back. If the user is in such a situation, the user may be able to view a computer display, but may not be able to view the input device without significant head movement. This type of head movement may be difficult and/or inadvisable for the incapacitated user. As such, the user may not be able to see how their hands are oriented with respect to the input device, making inputting of information difficult.

Further challenges are presented when different types of selections and/or operations are required to be performed by a user that a standard keyboard or a keyboard touch interface does not cater for.

### BRIEF SUMMARY OF THE INVENTION

In accordance with a first aspect of the present invention, there is provided an interface system for facilitating human interfacing with a computing device, the interface system comprising:

an input device arranged to detect touch based inputs made by an object and to communicate the detected inputs to the computing device;

a position detection system arranged to obtain positional information indicative of a position of respective portions of the object relative to the input device;
a shape recognition system arranged to:
use the positional information to determine a shape or configuration of the object;
compare the determined shape or configuration of the object to a predefined object shape or configuration; and
determine whether the shape or configuration of the object is substantially similar to the predefined object shape or configuration; and

data storage for storing information indicative of the predefined object shape or configuration;

wherein the interface system is arranged to select a touch based input mode in response to determining that the shape or configuration of the object is substantially similar to the predefined object shape or configuration.

The object may be a hand of a user of the interface system, and the shape or configuration of the object may be an orientation of the hand, and/or a shape formed by the hand.

In one embodiment, a plurality of predefined object shapes or configurations are stored in the data storage, each predefined object shape or configuration being associated with a respective touch based input mode of a plurality of touch based input modes, and the interface system is arranged to:

compare the determined shape or configuration of the object with the plurality of predefined object shapes or configurations; and

select the touch based input mode associated with the predefined object shape or configuration that the determined shape or configuration of the object is substantially similar to.

The touch based input modes may vary from one another by a sensitivity with which the input device detects touch based inputs made by the object, or by a way in which the interface system interprets the touch based input for interacting with the computing device. The touch based input modes may comprise any one of: a typing mode, a pointer mode, a scrolling and/or panning mode, a zoom in and/or a zoom out mode, and a menu mode. The menu mode may be one of a plurality of menu modes, each menu mode having a different input sensitivity, manner in which a touch based input is interpreted, and/or menu style.

The interface system may be arranged to facilitate display of visual information on a display of the computing device, the visual information being indicative of an input layout of the input device. The displayed input layout may correspond to the selected touch based input mode. It will be appreciated that, for at least one selected touch based input mode, the corresponding input layout may not be displayed.

Further, or alternatively, for embodiments wherein the input device comprises a display, the interface system may be arranged to facilitate display of visual information on the input device display indicative of an input layout of the input device. The displayed input layout may correspond to the selected touch based input mode. It will be appreciated that, for at least one selected touch based input mode, the corresponding input layout may not be displayed.

The interface system may be arranged to facilitate display of visual information on the computing device display indicative of the position of the object relative to the input layout. The interface system may be arranged to facilitate display of a representation of the object relative to the input layout of the input device. The displayed representation of the object may depend on the selected touch based input mode. The displayed representation of the object may be a pointer icon or similar, or a graphical representation of the object.

The representation of the object may indicate a distance between at least a portion of the object and the input layout of the input device. In one embodiment, the indication of the distance between the at least a portion of the object and the input layout is represented as colour or shading information.

Further, or alternatively, the indication of the distance between the at least a portion of the object and the input layout is provided by altering a transparency level of a portion of the representation corresponding to the at least a portion of object. The interface system may be arranged such that the displayed representation of the at least a portion of the object becomes more transparent the further away the at least a portion of the object is from the input layout.

In one embodiment, the interface system is arranged such that a representation of at least a portion of the object is not displayed if a distance between the at least a portion of the object and the input layout is greater than a predetermined threshold.

The interface system may be arranged to facilitate a visual representation on a display of the computing device of a touch event, the touch event corresponding to the object touching the input device. The touch event may be represented by highlighting an area of a representation of the input device that corresponds to a location of the touch event.

In one embodiment, the input device comprises a touch screen interface. The input device may be arranged to enable an input layout of the touch screen interface to be altered, wherein the interface system is arranged to facilitate display of the altered input layout on the computing device display.

The input device may comprise first and second input device portions. The interface system may be arranged to select a touch based input mode for the first input device portion based on a shape or configuration of a first object relative to the first input device portion, and to select a touch based input mode for the second input device portion based on a shape or configuration of a second object relative to the second input device portion.

The interface system may be arranged to facilitate display of visual information on the computing device display indicative of an input layout of each of the first and second input device portions.

The first and second input device portions may be couplable together in a releasably engagable configuration.

The system may be arranged to facilitate displaying representations of respective layouts of the first and second input device portions on a display of the computing device separately.

In one embodiment, the interface system is arranged to prevent display of visual information associated with the interface system and/or information being input via the interface system when a trigger condition exists. The trigger condition may correspond to entering sensitive information.

In one embodiment, the interface system is arranged to receive orientation information indicative of an orientation of virtual or augmented reality glasses and to use the orientation information to determine when to display visual information associated with the interface system. The system may be arranged to display the visual information when the received orientation information is indicative of a downwards tilt of the virtual or augmented reality glasses.

In one embodiment, the interface system comprises:

a movement recognition system arranged to:
use the positional information to determine a movement of the object;
compare the determined movement of the object to a predefined movement profile; and
determine whether the movement of the object is substantially similar to the predefined movement profile; wherein
   the data storage stores information indicative of the predefined movement profile and the interface system is arranged to select a touch based input mode in response to determining that the movement of the object is substantially similar to the predefined movement profile.

In accordance with a second aspect of the present invention, there is provided an interface system for facilitating human interfacing with a computing device, the interface system comprising:

an input device arranged to detect touch based inputs made by an object and to communicate the detected inputs to the computing device;

a position detection system arranged to obtain positional information indicative of a position of the object relative to the input device;

a movement recognition system arranged to:
use the positional information to determine a movement of the object;
compare the determined movement of the object to a predefined movement profile; and
determine whether the movement of the object is substantially similar to the predefined movement profile; and

data storage for storing information indicative of the predefined movement profile;

wherein the interface system is arranged to select a touch based input mode in response to determining that the movement of the object is substantially similar to the predefined movement profile.

The interface system of the first or second aspects of the present invention may be spaced apart from the computing device.

In accordance with a third aspect of the present invention, there is provided a method of interfacing with a computing device comprising the steps of:

storing information indicative of a predefined object shape or configuration;

obtaining positional information indicative of a position of respective portions of an object relative to an input device, the input device being arranged to detect touch based inputs made by an object and to communicate the detected inputs to the computing device;

using the positional information to determine a shape or configuration of the object;

comparing the determined shape or configuration of the object to the predefined object shape or configuration;

determining whether the shape or configuration of the object is substantially similar to the predefined object shape or configuration; and

selecting a touch based input mode in response to determining that the shape or configuration of the object is substantially similar to the predefined object shape or configuration.

The object may be a hand of a user of the interface system, and the shape or configuration of the object may be an orientation of the hand, and/or a shape formed by the hand.

In one embodiment, a plurality of predefined object shapes or configurations are provided, each predefined object shape or configuration being associated with a respective touch based input mode of a plurality of touch based input modes, and wherein the method comprises the steps of:

comparing the determined shape or configuration of the object with the plurality of predefined object shapes or configurations; and

selecting the touch based input mode associated with the predefined object shape or configuration that the determined shape or configuration of the object is substantially similar to.

The touch based input modes may vary from one another by a sensitivity with which the input device detects touch based inputs made by the object, or by a way in which the interface system interprets the touch based input for interacting with the computing device.

In one embodiment, the touch based input modes comprise any one of: a typing mode, a pointer mode, a scrolling and/or panning mode, a zoom in and/or a zoom out mode, and a menu mode.

The menu mode may be one of a plurality of menu modes, each menu mode having a different input sensitivity, manner in which a touch based input is interpreted, and/or menu style.

The method may comprise the step of displaying visual information on a display of the computing device, the visual information being indicative of an input layout of the input device.

In one embodiment, the displayed input layout corresponds to the selected touch based input mode.

The method may comprise the step of displaying visual information on a display of the computing device, the visual information being indicative of the position of the object relative to the input layout.

In one embodiment, the method comprises displaying a representation of the object relative to the input layout of the input device. The representation of the object may indicate a distance between at least a portion of the object and the input layout of the input device.

The method may comprise visually representing a touch event on a display of the computing device, the touch event corresponding to the object touching the input device.

The touch event may be represented by highlighting an area of a representation of the input device that corresponds to a location of the touch event.

In one embodiment, wherein the input device comprises first and second input device portions, the method comprises the steps of:

selecting a touch based input mode for the first input device portion based on a shape or configuration of a first object relative to the first input device portion; and

selecting a touch based input mode for the second input device portion based on a shape or configuration of a second object relative to the second input device portion.

The method may comprise the step of displaying visual information on a display of the computing device that is indicative of an input layout of each of the first and second input device portions.

In one embodiment, the method comprises the steps of:

receiving orientation information indicative of an orientation of virtual or augmented reality glasses; and

determining when to display visual information associated with the interface system based on the received orientation information.

The method may comprise the steps of:

providing information that is indicative of a predefined movement profile;

using the positional information to determine a movement of the object;

comparing the determined movement of the object to the predefined movement profile;

determining whether the movement of the object is substantially similar to the predefined movement profile; and

selecting a touch based input mode in response to determining that the movement of the object is substantially similar to the predefined movement profile.

In accordance with a fourth aspect of the present invention, there is provided a method of interfacing with a computing device comprising the steps of:

providing information indicative of a predefined movement profile;

obtaining positional information indicative of a position of an object relative to an input device, the input device being arranged to detect touch based inputs made by an object and to communicate the detected inputs to the computing device;

using the positional information to determine a movement of the object;

comparing the determined movement of the object to the predefined movement profile;

determining whether the movement of the object is substantially similar to the predefined movement profile; and

selecting a touch based input mode in response to determining that the movement of the object is substantially similar to the predefined movement profile.

The method of the third or fourth aspects of the present invention may be performed at an interface system that is spaced apart from the computing device.

In accordance with a fifth aspect of the present invention, there is provided a computer program arranged when loaded into a computing device to instruct the computing device to operate in accordance with the system of the first or second aspects of the present invention.

In accordance with a sixth aspect of the present invention, there is provided a computer readable medium having a computer readable program code embodied therein for causing a computing device to operate in accordance with the system of the first or second aspects of the present invention.

In accordance with a seventh aspect of the present invention, there is provided a data signal having a computer readable program code embodied therein to cause a computing device to operate in accordance with the system of the first or second aspects of the present invention.

### BRIEF DESCRIPTION OF THE DRAWINGS

In order that the present invention may be more clearly ascertained, embodiments of the present invention will now be described, by way of example only, with reference to the accompanying drawings, in which:

FIG. 1 is a schematic diagram of an interface system in accordance with an embodiment of the present invention;

FIG. 2 is an example screen shot of visual information that is displayed on a display of a computing device, the display of the visual information being facilitated by the interface system of FIG. 1;

FIG. 3a is a top view of an input device of the interface system of FIG. 1, the input device being shown in a coupled configuration;

FIG. 3b is a top view of the input device of FIG. 3a, the input device being shown in a split configuration;

FIG. 4 is a flow diagram of a method of interfacing with a computing device in accordance with an embodiment of the present invention; and

FIGS. 5a to 5k are top views of an input of the interface system of FIG. 1 and illustrating various example shapes and configurations of a user's hand that are used in the selection of associated touch based input modes.

### DETAILED DESCRIPTION OF THE INVENTION

In general, there is provided an interface system for facilitating human interfacing with a computing device, and a method of interfacing with a computing device.

The interface system comprises a touch based input device, for example a keyboard, arranged to detect touch based inputs. The touch based input device may, for example, be a conventional type keyboard having physical keys and that detects keystrokes as the keys are depressed by a user. Alternatively, the touch based input device may be a touch screen based keyboard, for example a touch screen that is arranged to display an input layout and that detects when a user touches parts of the screen corresponding to inputs of the input layout.

In addition to providing a touch based input device, the interface system is arranged to detect a position of respective portions of an object relative to the touch based input device. Since a user typically uses his or her hands to enter information via the touch based input device, at least one of the user's hands will typically be the object detected by the interface system.

The interface system also comprises a shape recognition system arranged to use the positional information to determine a shape or configuration of the object, in this case an orientation and/or a shape formed by the user's hand. The interface system then compares the determined shape or configuration of the object to predefined object shapes or configurations and determines whether the shape or configuration of the object is substantially similar to any of the predefined object shapes or configurations. Information indicative of the predefined object shapes or configurations is stored in data storage of the interface system, each predefined object shape or configuration being associated with a respective touch based input mode of a plurality of touch based input modes.

The interface system is arranged to select the touch based input mode associated with the predefined object shape or configuration that the determined shape or configuration of the object is substantially similar to.

Further, or alternatively, the interface system can comprise a movement recognition system arranged to use the positional information to determine a movement of the user's hand. The interface system can then compare the determined movement of the user's hand to predefined movement profiles to determine whether the movement of the user's hand is substantially similar to any of the predefined movement profiles. Information indicative of the predefined movement profiles is stored in the data storage of the interface system, each predefined movement profile being associated with a respective touch based input mode of a plurality of touch based input modes.

The interface system is arranged to select the touch based input mode associated with the predefined movement profile that the determined movement of the user's hand is substantially similar to.

The interface system can therefore facilitate switching between touch based input modes based on a shape or configuration of a user's hand and/or based on a movement of a user's hand. Using shape and/or movement recognition to change a mode and/or a form of a user interface dynamically allows a variety of menu, keyboard and pointer selections to be provided to the user to provide input to a computing device.

The relative position of the user's hands, that is, the object, with respect to the touch based input device can also be visually represented, for example on a display of the computing device. The visual representation may be a representation of the actual shape of the object, or the object may be represented as a different shape, such as a pointer icon.

Visually representing the relative position of the user's hands with respect to the touch based input device provides visual feedback to the user indicating where the user's hands are in relation to the touch based input device. The user can use this visual feedback to arrange the user's fingers over keys he or she desires to touch so as to enter desired information, or to make various other touch based inputs depending on the selected touch based input mode. This can be of particular advantage when the user cannot, or finds it difficult to, look at the input device when inputting information but is able to view the display of the computing device.

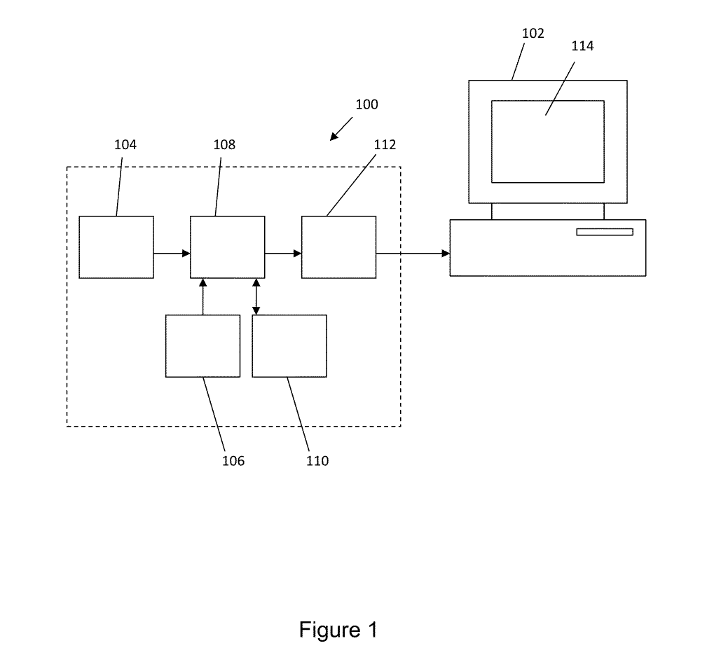

A specific example of an interface system 100 will now be described with reference to FIG. 1. In the following description, the interface system 100 uses shape recognition to select a touch based input mode, although it will be appreciated that movement recognition can be used to select a touch based input mode in addition to, or in place of, shape recognition. Therefore, throughout the following description, references to a shape recognition system and predefined object shapes or configurations can be replaced with references to a movement recognition system and predefined movement profiles respectively, or the interface system 100 may comprise a movement recognition system in addition to a shape recognition system, the movement and shape recognition systems being usable separately or together to select a touch based input mode.

In the example shown in FIG. 1, the interface system 100 is arranged to facilitate human interfacing with a computing device 102 and comprises a touch based input device 104 arranged to detect touch based inputs made by an object, such as a user's hand. The interface system 100 also comprises a position detection system 106 arranged to obtain positional information indicative of a position of the object relative to the input device 104. The input device 104 and position detection system 106 respectively communicate the touch based input and the positional information to a processor 108 of the interface system 100.

The processor 108 can function as the shape recognition system, and is arranged to use the positional information to determine the shape or configuration of the user's hand.

The interface system 100 also comprises a memory 110 which is in communication with the processor 108. The memory 110 stores the predefined object shapes and configurations and their associated touch based input modes, and also stores any programs, firmware or the like used by the interface system 100 to perform its various functions.

The processor 108 compares the determined shape or configuration of the user's hand to the predefined object shapes or configurations stored in the memory 110. Based on this comparison, the processor 108 determines whether the shape or configuration of the object is substantially similar to any of the predefined object shapes or configurations.

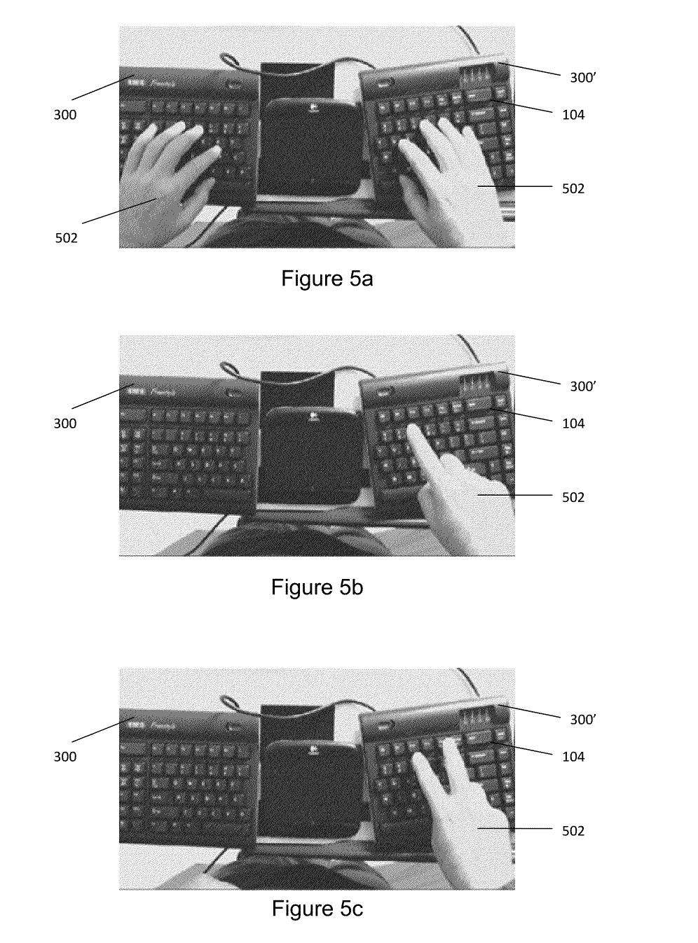

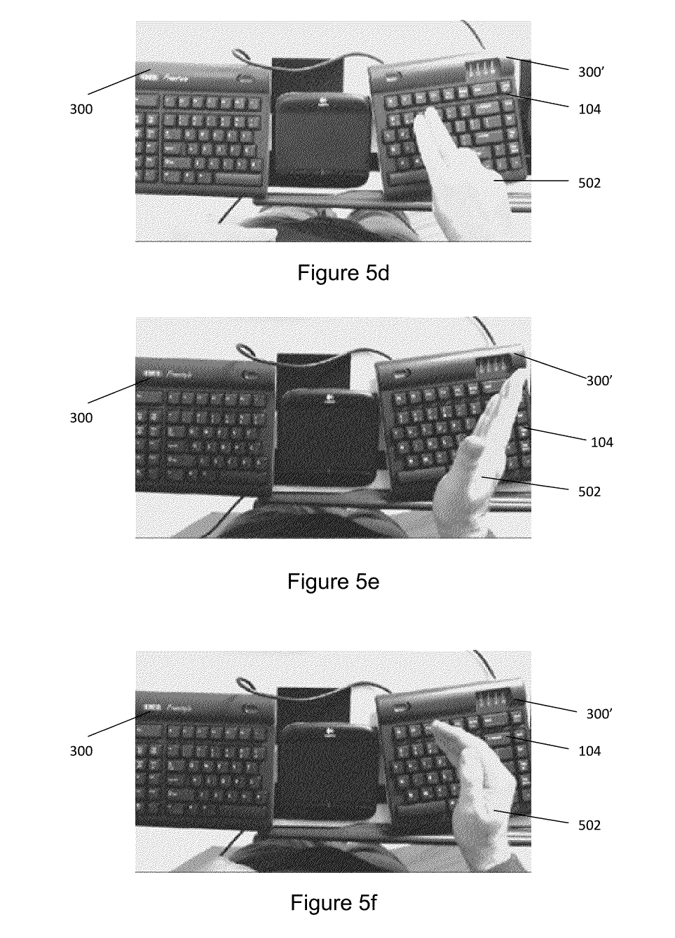

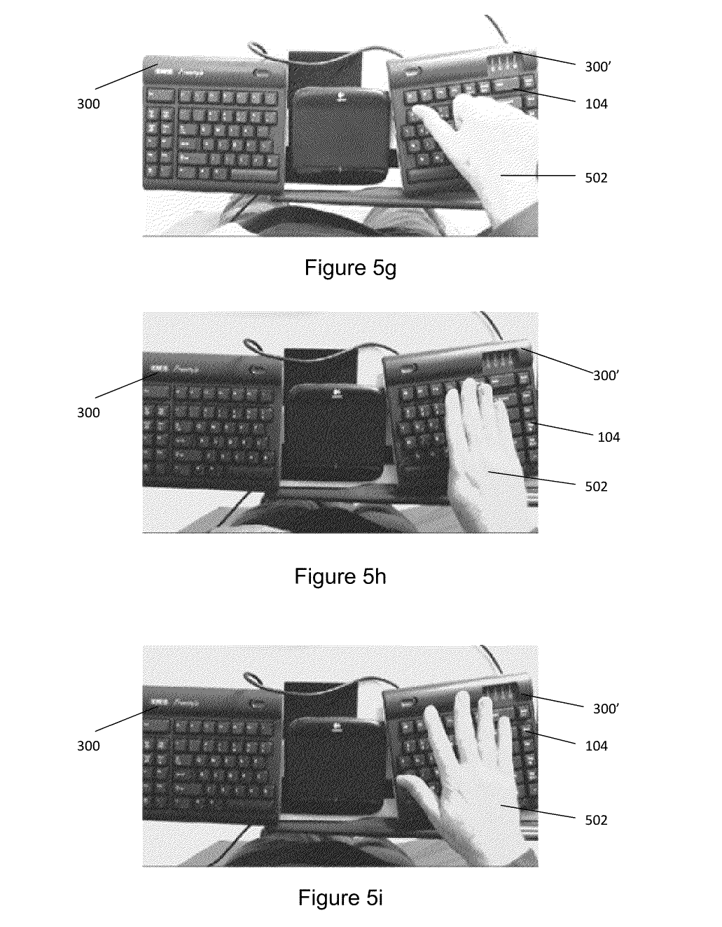

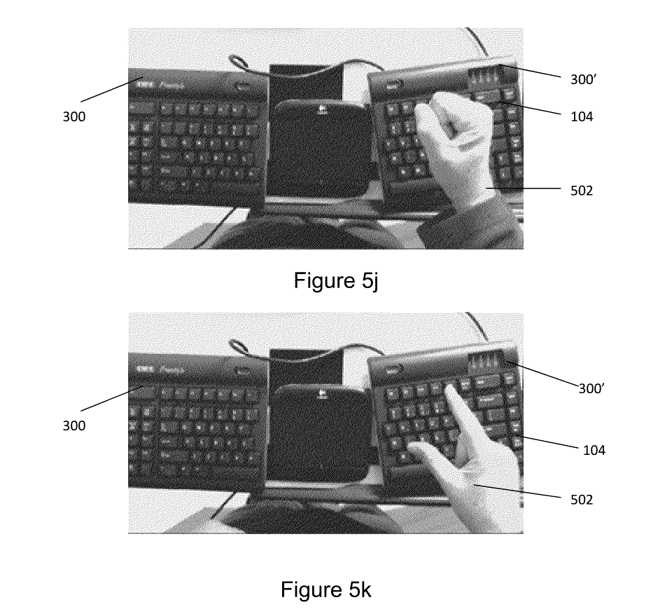

The processor 108 then selects the touch based input mode associated with the predefined object shape or configuration that the determined shape or configuration of the object is substantially similar to, and instructs the interface device 104 to operate in accordance with the selected touch based input mode. Examples of various touch based input modes and their respective associated object shapes or configurations are described later with reference to FIGS. 5a to 5k.

The processor 108 is also arranged to receive the touch based input and positional information and to process this information so as to provide visual information that is indicative of a position of the object relative to the input device 104 to assist the user in operation of the input device 104. The processor 108 is also arranged to provide visual information that is indicative of the input layout of the input device 104 based on input layout information received from the input device 104.

The visual information and information that is indicative of the selected touch based input mode are communicated to a communications device 112 for subsequent communication to the computing device 102. In this example, the communications device 112 is a wireless communications device that utilises an appropriate wireless protocol such as Bluetooth so as to communicate the visual information and the selected touch based input mode information to the computing device 102 wirelessly. The computing device 102 is arranged to wirelessly receive the visual information and the selected touch based input mode information communicated from the communications device 112 and to display the visual information on a display 114 of the computing device 102 and other information that may be appropriate based on the selected touch based input mode.

In the above example, the interface system 100 is described as comprising a processor 108 that is arranged to perform the various functions of the interface system 100, although it will be appreciated that appropriate software can be installed on the computing device 102 so as to allow a processor of the computing device 102 to perform a similar function. In such an arrangement, the input device 104 and the position detection system 106 may communicate touch based inputs and positional information, either by a wired or wireless connection, to the computing device 102 wherein the shape detection, touch based input mode selection and visual information is provided by the processor of the computing device 102.

In the example shown in FIG. 1, the interface system 100 is a touch screen based input device that is arranged to provide touch based inputs received from the user via a touch screen, and wherein the position of the user's hands is detected by an infrared sensing system. Examples of touch screen input devices that utilise both touch screen based inputs and object position detection include 3D proximity sensing touch screens manufactured by Mitsubishi Electric Corporation, Cypress Semiconductor Corporation's Hover Detection for TrueTouch touch screens, and the PixelSense technology used in Microsoft Corporation's Surface 2.0 device.

The touch screen based input device is also arranged to provide haptic feedback to the user. For example, the touch screen based input device can be arranged so as to provide the user with physical feedback coinciding with when the user inputs information, analogous to feedback a user would feel when inputting information via a traditional keyboard.

Although a device that offers both touch based input detection and object position detection can be used, it will be appreciated that these functions can be provided by separate devices, and it will be appreciated that any appropriate technologies that are able to provide these functions can be used. For example, the touch based input detection can be provided by capacitive touch sensing or resistive touch sensing technologies, and the object position detection can be provided by an infra red based position detection system or a capacitive position detection system. It will be appreciated that capacitive sensing technology can be used for both touch and position detection.

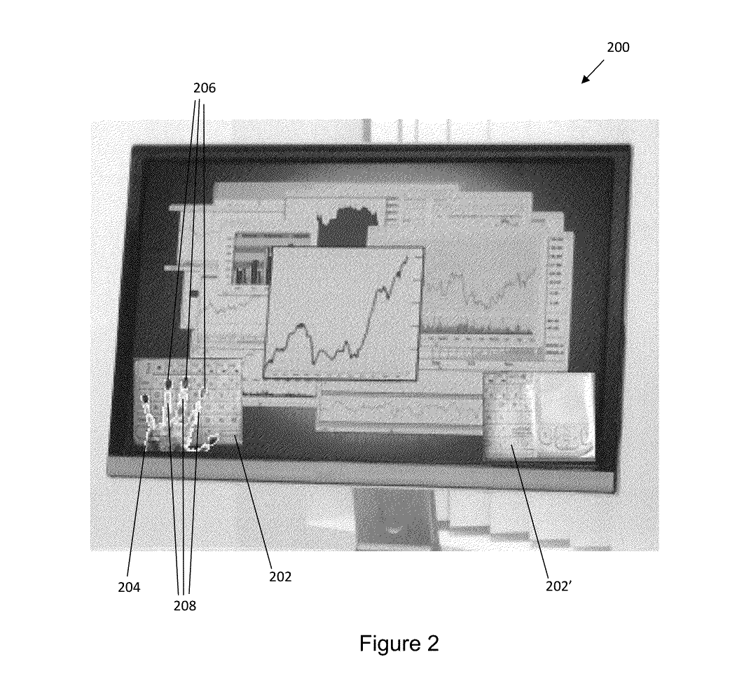

An example screen shot 200 from the computing device display 114 is shown in FIG. 2. The screen shot 200 shows a representation 202 of an input layout of the touch based input device 104, and a representation 204 of the user's hand in accordance with the visual information provided by the interface system 100. When the user moves his or her hand, the position detection system 106 will detect the new position of the user's hand, and the representation 204 of the user's hand will be updated accordingly. In this way, the user is provided with substantially real time feedback regarding the position of the user's hand relative to the input layout of the input device 104.

The representation 204 of the user's hand also indicates how far parts of the hand are from the input layout of the input device 104. In this example, the further away a part of the user's hand, the lighter the shading used in a corresponding portion of the representation 204. For example, portions 206 of the representation 204 corresponding to finger tips of the user are shaded darker than portions 208 of the representation 204 corresponding to intermediate finger portions, indicating that the finger tips are closer to the input layout of the input device 104 than the intermediate finger portions. Although shading is used in this example to provide an indication of how far parts of the user's hand are from the input layout of the input device 104, it will be appreciated that colours could be used for a similar purpose wherein different colours correspond to different distances from the input device 104.

Further, or alternatively, a transparency level of the representation 204 can be altered to provide the user with feedback as to the distance the user's hand is from the input device 204. In particular, the interface system 100 can be arranged to cause the representation 204 to become more transparent the further the user's hand is from the input device 104, and wherein when the user's hand is a predefined distance from the input device 104, the representation 204 is not displayed. The predefined distance may be in the order of centimeters, such as 5 cm. In one example, the predefined distance is substantially a distance that a user's finger can reach when bent away from the palm.

It will be appreciated that, even if the interface system 100 is not arranged to alter the transparency level of the representation 204, the interface system 100 may still be arranged to no longer display the representation 204 when the user's hand is beyond the predefined distance from the input device 104.

When the user touches the input device 104, the interface system 100 is arranged to provide a corresponding visual indication. For example, an area of the representation 202 of the input device 104 corresponding to an area of the input device 104 that was touched can be highlighted at the time the touch occurs.

In this example, the input device 104 is arranged to enable an input layout of its touch screen interface to be altered and is particularly arranged to change dynamically based on current user interface input needs. For example, if the user is entering information into a field that requires only numbers, the touch screen interface of the input device is arranged to only display numbers, and to display the full standard alphanumeric keyboard face at other times. To cater for this, the interface system 10 is arranged to facilitate display of the altered input layout on the computing device display 114.

In addition to displaying the input layout of the input device 104 on the display 114, for embodiments wherein the input device 104 comprises a display, the interface system 100 can be arranged to facilitate display of visual information on the display of the input device 104 that is indicative of an input layout of the input device 104 (not shown). The displayed input layout may correspond to the selected touch based input mode. It will be appreciated that, for at least one selected touch based input mode, the corresponding input layout may not be displayed. For example, if the input more corresponds to a ‘pointer’ type input mode, an input layout may not be displayed on the display of the input device 104.

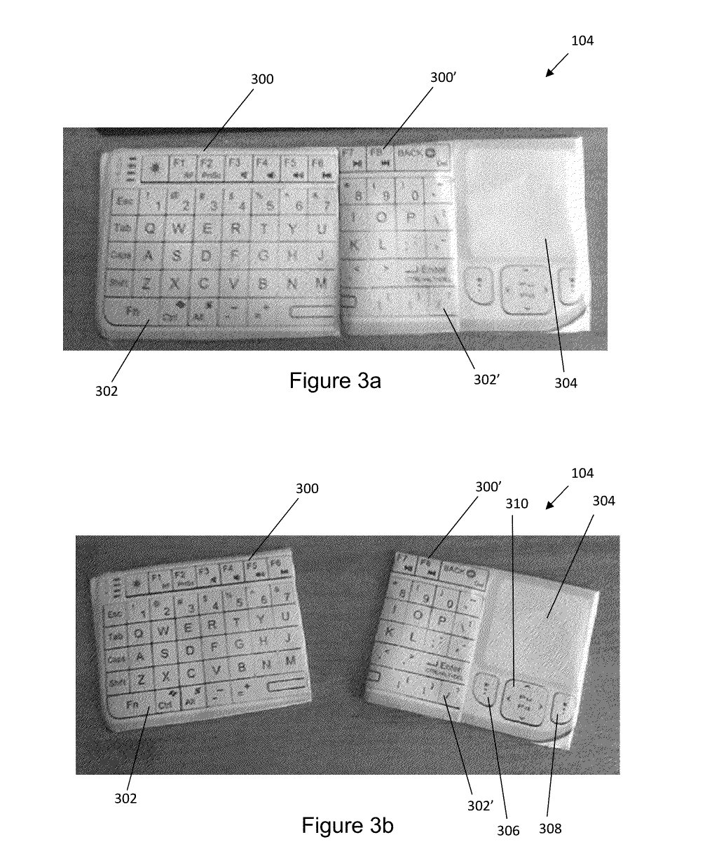

In this example, and referring now to FIGS. 3a and 3b, the input device 104 comprises separate first and second input device portions 300, 300′. The first and second input device portions 300, 300′ are releasably engagable with one another so as to allow the input device portions 300, 300′ to be either joined together so as to function as a typical keyboard (see FIG. 3a showing the input device portions 300, 300′ in a coupled configuration), or to be separated so as to function as a split keyboard (see FIG. 3b showing the input device portions 300, 300′ in a split configuration).

Each input device portion 300, 300′ has a respective input layout 302, 302′. In this example, the input layout 302 of the first input device portion 300 substantially corresponds to an input layout that would typically be found on a left-hand side of a standard keyboard, and the input layout 302′ of the second input device portion 300′ substantially corresponds to an input layout that would typically be found on a right-hand side of a standard keyboard. In this example, the input layout 302′ of the second input device portion 300′ includes a trackpad portion 304 for enabling a user to move a pointer or similar displayed on the display 114, ‘left’ and ‘right’ buttons 306, 308 corresponding to the functions of left and right mouse buttons, and a navigation button array 310 for enabling the user to perform such functions as scrolling.

The interface system 100 is arranged to display the input layout of each of the first and second input device portions 300, 300′ on the computing device display 114 as respective representations 202, 202′ as shown in FIG. 2.

The interface system 100 is also arranged to prevent display of the visual information on the computing device display 114 under certain circumstances, such as when the user is entering sensitive information. This may be triggered automatically, such as when the interface system 100 detects that a password or the like is required to be entered, or it may be triggered manually in response to the user pressing an appropriate function button or issuing an appropriate command.

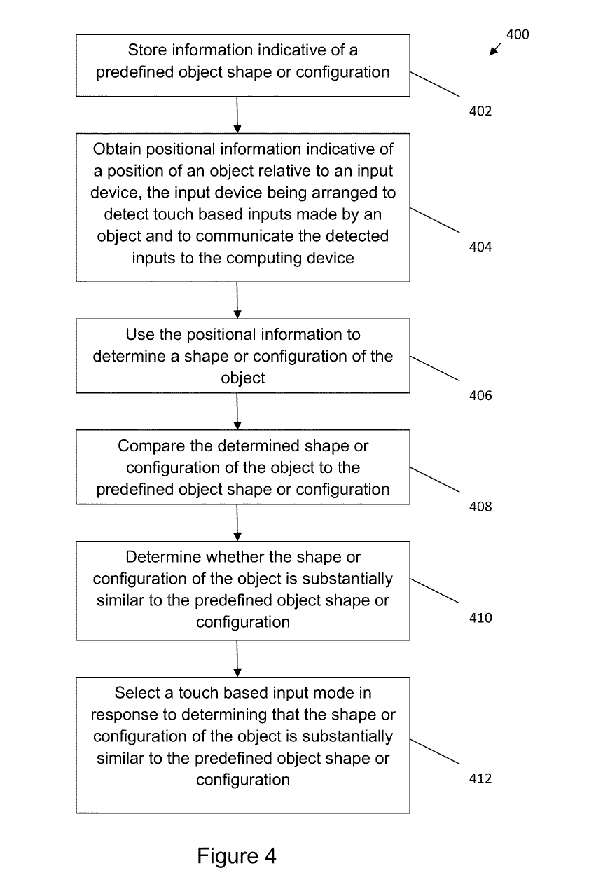

A method 400 of interfacing with a computing device, such as computing device 102, is now described with reference to FIG. 4. In a first step 402, the method 400 comprises storing information indicative of a predefined object shape or configuration. In a second step 404, positional information indicative of a position of an object relative to the input device 104 is obtained. The input device 104, as described earlier, is arranged to detect touch based inputs made by an object and to communicate the detected inputs to the computing device 102.

A third step 406 of the method 400 comprises using the positional information to determine a shape or configuration of the object. The determined shape or configuration of the object is then compared to the predefined object shape or configuration in a fourth step 408, and in a fifth step 410 it is determined whether the shape or configuration of the object is substantially similar to the predefined object shape or configuration.

Finally, in a fifth step 412, a touch based input mode is selected in response to determining that the shape or configuration of the object is substantially similar to the predefined object shape or configuration.

For embodiments that use movement recognition to select a touch based input mode in addition to, or in place of, shape recognition, the method 400 may comprise a step of providing information that is indicative of a predefined movement profile. In such embodiments, the method 400 may also comprise using the positional information to determine a movement of the object, comparing the determined movement of the object to the predefined movement profile, determining whether the movement of the object is substantially similar to the predefined movement profile, and selecting a touch based input mode in response to determining that the movement of the object is substantially similar to the predefined movement profile.

The method 400 can be carried out using the interface system 100 described herein.

Example predefined object shapes and configurations, and their associated touch based input modes, will now be described with reference to FIGS. 5a to 5k. In each FIGS. 5a to 5k, at least one user hand 502 is shown interacting with either a first or second input device portion 300, 300′ of an input device 104. When the interface system 100 determines that the user's hand 502 is substantially similar to a predefined object shape or configuration, the interface system 100 selects the associated touch based input mode for the input device 104 to function in.

FIG. 5a shows an example of a ‘typing’ touch based input mode. In this example, the user's hand 502 is open with the fingers slightly separated, but not fully out-stretched. The shape of the user's hand 502 as shown in FIG. 5a has associated therewith a touch based input mode based on a standard keyboard layout. The layout of the keyboard can change depending on the context of the currently selected application.

FIG. 5b shows an example of a ‘pointing’ touch based input mode. In this example, the user's hand is arranged with a single outstretched finger. The touch based input mode associated with the shape of the user's hand as shown in FIG. 5b is a screen touch mode. The region of the input device 104 below the user's hand 502 will represent the entire viewing screen region of the display 114 and not, for example, a keyboard surface.

Rather than displaying a visual representation of an onscreen keyboard, a representation of a potential touch point will be displayed on the display 114. The representation of the potential touch point can be an outline of the user's hand 502 or a single potential touch point “mouse” pointer. In this mode, the input device 104 acts as a proxy for the entire display 114. Put another way, the input device 104 functions conceptually like a tablet computing device that the user interacts with to produce a corresponding “mouse” pointer movement on the display 114.

In this example, a pointer click event occurs and is processed only when the outstretched finger of the user's hand 502 touches a surface of the input device 104.

FIG. 5c shows an example of a ‘scrolling and panning’ touch based input mode. In this example, the user's hand 502 is arranged with two outstretched fingers with a slight separation therebetween. The shape of the user's hand 502 indicates a scrolling and panning mode. Whether the interface system 100, or the computing device 102, interprets the user's touch as a ‘scrolling’ or as a ‘panning’ command depends on the currently selected application's state.

FIG. 5d shows an example of a ‘two fingered menu’ touch based input mode. The user's hand 502 in this example is arranged with two outstretched fingers with no separation therebetween. This shape is associated with the ‘two fingered menu’ mode. In ‘two fingered menu’ mode, the accuracy of touch points is less than that of a single finger touch point yet the accuracy is still quite reasonable. The ‘two fingered menu’ mode is suitable for a dedicated large key keyboard, such as a numeric keyboard, or application specific menus.

FIG. 5e shows an example of a ‘chop menu’ touch based input mode. In this example, the user's hand 502 is oriented such that the user's fingers and thumb are aligned so that the person can perform a ‘chopping’ motion with their hand. The user's hand 502 can be rotated in an arc about the user's wrist with the fingers and thumb together. The ‘chop menu’ mode is appropriate, for example, for a radial menu wherein the touch point areas coincide with different sectors of an arc. In this example, a touch event is determined to occur when the user's hand 502 is lowered so that a lowermost finger, in this example the user's little finger, touches the surface of the input device 104.

FIG. 5f shows an example of a ‘curved hand menu’ touch based input mode. The user's hand 502 is oriented such that the fingers and thumb are together but the fingers of the hand 502 are slightly curled inwards. A touch event is determined to occur when the user's hand 502 is lowered so that a lowermost finger, in this example the user's little finger, touches the surface of the input device 104.

The dynamic action of curling the fingers of the hand 502 repeatedly is used to change between menu sets. An example of the usage of the ‘curved hand menu’ mode is to select between currently running applications. For example, a list of five currently running applications could be displayed when the user arranges his or her hand in the shape of the hand 502 as shown in FIG. 5f. Curling the fingers of the hand 502 dynamically would then display the next five running application selection options. This is analogous to the ‘Windows-tab’ key behaviour in Windows 7.

FIG. 5g shows an example of a ‘thumb menu’ touch based input mode. In this example, the user's hand 502 is arranged such that the fingers are closed inwards to the palm with the thumb outstretched. Such an arrangement will bring up a ‘thumb menu’, a menu having menu entries that are selectable by a thumb touch event. A thumb touch event is determined to occur when the thumb of the user's hand 502 touches the surface of the input device 104.

FIG. 5h shows an example of a ‘four fingered menu’ touch based input mode. In this example, four fingers of the user's hand 502 are held together and the user's thumb is folded under the palm. Such an arrangement provides a relatively large touch surface across the four fingers. This hand configuration is associated with the ‘four fingered menu’ mode and is applicable to menus having few options and relatively large touch points.

FIG. 5i shows an example of an ‘out-stretched hand menu’ touch based input mode.

An outstretched hand with separation between all fingers and the thumb can be used as a global means of quickly getting back to an operating system's start menu. The user can then arrange his or her hand 502 into the configuration shown in FIG. 5b to cause the input device 104 to function in ‘pointing’ touch based input mode to facilitate selection of a start menu option. The Windows 8 tiled start menu is an example of a global menu that would benefit from this gesture.

FIG. 5j shows an example of a ‘fist menu’ touch based input mode. In this example, the user's hand 502 is arranged in an upright fist. The user's first obscures a significant portion of the input device 104, and the ‘fist menu’ mode is therefore appropriate for use with menus that have low accuracy requirements. A touch event is determined to occur when a side of the user's lowermost finger touches the surface of the input device 104.

FIG. 5k shows an example of a ‘pinch and zoom’ touch based input mode. In this example, the user's hand 502 is arranged such that the first finger and thumb are extended with a separation therebetween. Pinch and/or zoom events are determined to occur when touch events are determined to occur, although visuals presented on the display 114 can change state when a user's hand 502 is recognised to be arranged in the shape shown in FIG. 5k before the touch event is determined to occur. For example, the display 114 can change visual state and display the user's hand 502 in the shape corresponding to the ‘pinch and zoom’ touch based input mode, and a keyboard layout and/or any previously displayed menus may be removed from display to provide a visual cue to the user that the interface system 100 has selected the ‘pinch and zoom’ touch based input mode.

The interface system 100 can be used for different applications. In one example, the interface system 100 can be used with multiple displays. Touch based input modes such as the ‘pointing’ touch based input mode typically map the area of a single display onto the area of the surface of the input device 104. Mapping the area of multiple displays to the same area will result in a loss in pointing accuracy. To counter this loss in accuracy, an eye gaze tracking system (not shown) can be used across multiple displays. The display that the eye gaze tracking system detects the user to be viewing can be the display that is mapped to the input device 104. The accuracy of the eye tracking system only needs to be to the level of detecting which display the user is looking at.

The interface system 100 can also be used in standard desktop computing use, and, with the various touch based input modes such as the ‘pointing’ touch based input mode, may be used to replace the mouse in many scenarios. Detecting the position of the user's hand 502 to a sub-millimeter scale may facilitate replacing the mouse as a pointing mechanism. The desktop computing use scenario then becomes analogous to the touch based user interfaces that are used on various tablet computing and mobile phone devices. Providing similar user interface paradigms across the tablet and desktop versions of an operating system family has interaction and technological advantages.

From an ergonomic point of view, it also means that a person's head does not need to be bowed down for long periods of time and can be kept level with displays that are mounted for eye level viewing. Using the interface system 100 also means that a user is free to position their input device(s) 104 anywhere and in any orientation and still effectively use them. This can help reduce shoulder hunching, neck ache and tight middle back issues.

The interface system 100 can also be used with a hybrid laptop system wherein the keyboard is also a touch based screen. The interface system 100 provides advantages over standard touch screen technology as different input modes can be provided according to the various touch based input modes selected based on the shape or configuration of the user's hands 502.

When the interface system 100 is used in a hybrid laptop scenario, the surface of the input device 104 is physically close to the display. In such scenarios, a visual representation of the input device 104 may not be provided on the display, although the aforementioned selectable touch based input modes and context sensitive keyboard and menu layouts still apply.

The interface system 100 can also support separating the input device 104 and display modules in hybrid laptop use. This would then put the display in a visual representation of the input device 104 is provided on the display.

The interface system 100 can also be used with a tablet computing device, even if a separate input device 104 is not provided. For example, the menu type touch based input modes described earlier can apply to a tablet user interface wherein an appropriate menu user interface is displayed when the user arranges their hand in a corresponding shape or configuration. The menu user interface can be removed from display when the user exits the current touch based input mode by changing the shape of configuration of the user's hand or initiates a touch event.

In a further example, the input device 104 can be arranged in the split configuration wherein the first input device portion 300 is mounted on a left arm of a chair and the second input device portion 300′ is mounted on a right arm of a chair. In this way, repetitive stress problems associated with typical keyboard use wherein a user places their hands out in front of them can be avoided as the user can instead rest their arms on the left and right arms of the chair. The user is still able to enter information via the input device 104 since they are provided with visual feedback on the display 114 as to the relative position of their hands with respect to the input device 104. The user is not required to look down to orient their hands with respect to the first and second input device portions 300, 300′.

The interface system 100 can also be used to more conveniently utilise large displays, for example when a presenter is giving a presentation on a large screen in an auditorium. Since visual feedback is provided to the presenter as to the position of his hands relative to the input device 104, the presenter need not take his attention away from the display to orient his hands with respect to the input device 104. The visual feedback will also be provided to the audience, thereby providing the audience with additional information regarding information the presenter may be inputting during the presentation.

Further, a plurality of input devices 104 can be provided so as to allow multiple users to collaboratively work on the same application. For example, the first and second input device portions 300, 300′ can be separated and arranged to each provide a complete keyboard layout and trackpad. The first and second input portions 300, 300′ can then be provided to different users to enable the collaborative work.

In another application, the interface system 100 can be used to assist incapacitated users. For example, if a user is incapacitated and is required to lie flat on their back for long periods of time, the first and second input device portions 300, 300′ can be placed on respective sides of the user's body next to each hand. This can enable the user to input information via the input device 104 with minimal arm movements and in the prone position.

In a further application, virtual reality or augmented reality glasses can be used in place of the display 114 of the computing device 102. As these types of glasses take up a large portion, often the entirety, of the user's field of view, the interface system 100 can be used to enable the user to input information via the input device 104 without the need to remove the glasses since the visual feedback is provided via the glasses.

In one particular example of a virtual reality application, virtual reality glasses are provided with orientation sensors, for example sensors based on accelerometer technology, so as to allow an orientation of the glasses to be determined. The orientation of the glasses is communicated as orientation information to the interface system 100, such as via a Bluetooth connection, and the interface system 100 is arranged to use the orientation information to determine when to display a representation 202 of an input layout of the touch based input device 104, and a representation 204 of the user's hand.

For example, when the user's head is positioned so as to be looking straight ahead with respect to the orientation of the user's body, the interface system 100 is arranged to not display the representations 202, 204. Instead, the user is presented with a full view of their virtual reality environment. When the user looks down, such as with a slight tilt of the head, the change in orientation of the glasses is detected by the orientation sensors and the respective orientation information is communicated to the interface system 100. In response to receiving the orientation information, the interface system 100 is arranged to display the representations 202, 204. The representations 202, 204 can, for example, be shown in a location of the virtual reality environment that would correspond to a position of the input device 104 relative to the user in the real world.

In a still further application, if a user's view incorporates a heads up display (HUD), the interface system 100 can be arranged to provide visual feedback regarding the position of the user's hands with respect to the input device 104 via the HUD. This can enable the user to concentrate on the view and the HUD while still inputting information via the input device 104.

The interface system 100 can also in a car or vehicle scenario as it allows the user to interact with instrumentation (such as GPS, radio, music and worker specific controls) without the user's eye gaze needing to be shifted from the road, or by only slightly shifting the user's eye gaze from the road.

In one example in use with a car or vehicle, the input device 104 is arranged in a centre of a steering wheel and operated such that user hand/finger positions are always interpreted with the same orientation regardless of the rotation of the steering wheel.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

For example, it is envisaged that a mobile device such as a mobile telephone can be used as the input device 104. In particular, a programmable mobile device that has a touch screen input and that is able to provide position detection of objects relative to the touch screen can be used as an input device. Multiple users can then collaborate on a single display using their respective mobile devices. In such a scenario, the interface system 100 can be arranged to indicate on the display which mobile device is inputting what information and/or visually indicate which mobile device currently has priority to enter information.

Further, a television (TV) remote control may be an input device 104 of the interface system 100, and can be used to interact with and to control the TV. Further, or alternatively, an input device 104 that a user brings into a TV viewing room or similar, such as a tablet or mobile phone arranged to function as the interface system 100, can be used to interact with and to control the TV.

Further, it is envisaged that the system 100 or method 400 may be implemented as a computer program that is arranged, when loaded into a computing device, to instruct the computing device to operate in accordance with the system 100 or method 400.

Further, or alternatively, the system 100 or method 400 may be provided in the form of a computer readable medium having a computer readable program code embodied therein for causing a computing device to operate in accordance with the system 100 or method 400.

Still further, or alternatively, the system 100 or method 400 may be provided in the form of a data signal having a computer readable program code embodied therein to cause a computing device to operate in accordance with the system 100 or method 400.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. An interface system for facilitating human interfacing with a computing device, the interface system comprising:
an input device arranged to detect touch based inputs made by an object and to communicate the detected inputs to the computing device;
a position detection system arranged to obtain positional information indicative of a position of respective portions of the object relative to the input device;
a shape recognition system arranged to:
use the positional information to determine a shape or configuration of the object;
compare the determined shape or configuration of the object to a predefined object shape or configuration; and
determine whether the shape or configuration of the object is substantially similar to the predefined object shape or configuration; and
data storage for storing information indicative of the predefined object shape or configuration;
wherein the interface system is arranged to select a touch based input mode in response to determining that the shape or configuration of the object is substantially similar to the predefined object shape or configuration.

2. The interface system of claim 1, wherein the object is a hand of a user of the interface system, and the shape or configuration of the object is an orientation of the hand, and/or a shape formed by the hand.

3. The interface system of claim 1, wherein a plurality of predefined object shapes or configurations are stored in the data storage, each predefined object shape or configuration being associated with a respective touch based input mode of a plurality of touch based input modes, and the interface system is arranged to:
compare the determined shape or configuration of the object with the plurality of predefined object shapes or configurations; and
select the touch based input mode associated with the predefined object shape or configuration that the determined shape or configuration of the object is substantially similar to.

4. The interface system of claim 3, wherein the touch based input modes vary from one another by a sensitivity with which the input device detects touch based inputs made by the object, or by a way in which the interface system interprets the touch based input for interacting with the computing device.

5. The interface system of claim 3, wherein the touch based input modes comprise any one of: a typing mode, a pointer mode, a scrolling and/or panning mode, a zoom in and/or a zoom out mode, and a menu mode.

6. The interface system of claim 5, wherein the menu mode is one of a plurality of menu modes, each menu mode having a different input sensitivity, manner in which a touch based input is interpreted, and/or menu style.

7. The interface system of claim 1, wherein the interface system is arranged to facilitate display of visual information on a display of the computing device, the visual information being indicative of an input layout of the input device.

8. The interface system of claim 7, wherein the displayed input layout corresponds to the selected touch based input mode.

9. The interface system of claim 1, wherein the interface system is arranged to facilitate display of visual information on a display of the computing device, the visual information being indicative of the position of the object relative to the input layout.

10. The interface system of claim 9, wherein the interface system is arranged to facilitate display of a representation of the object relative to the input layout of the input device.

11. The interface system of claim 1, wherein the input device comprises a touch screen interface.

12. The interface system of claim 1, further comprising:
a movement recognition system arranged to:
use the positional information to determine a movement of the object;
compare the determined movement of the object to a predefined movement profile; and
determine whether the movement of the object is substantially similar to the predefined movement profile; wherein
the data storage stores information indicative of the predefined movement profile and the interface system is arranged to select a touch based input mode in response to determining that the movement of the object is substantially similar to the predefined movement profile.

13. An interface system for facilitating human interfacing with a computing device, the interface system comprising:
an input device arranged to detect touch based inputs made by an object and to communicate the detected inputs to the computing device;
a position detection system arranged to obtain positional information indicative of a position of the object relative to the input device;
a movement recognition system arranged to:
use the positional information to determine a movement of the object;
compare the determined movement of the object to a predefined movement profile; and
determine whether the movement of the object is substantially similar to the predefined movement profile; and
data storage for storing information indicative of the predefined movement profile;
wherein the interface system is arranged to select a touch based input mode in response to determining that the movement of the object is substantially similar to the predefined movement profile.

14. A method of interfacing with a computing device comprising the steps of:
providing information indicative of a predefined object shape or configuration;
obtaining positional information indicative of a position of respective portions of an object relative to an input device, the input device being arranged to detect touch based inputs made by an object and to communicate the detected inputs to the computing device;
using the positional information to determine a shape or configuration of the object;
comparing the determined shape or configuration of the object to the predefined object shape or configuration;
determining whether the shape or configuration of the object is substantially similar to the predefined object shape or configuration; and
selecting a touch based input mode in response to determining that the shape or configuration of the object is substantially similar to the predefined object shape or configuration.

15. The method of claim 14, wherein the object is a hand of a user of the computing device, and the shape or configuration of the object is an orientation of the hand, and/or a shape formed by the hand.

16. The method of claim 14, wherein a plurality of predefined object shapes or configurations are provided, each predefined object shape or configuration being associated with a respective touch based input mode of a plurality of touch based input modes, and wherein the method comprises the steps of:
comparing the determined shape or configuration of the object with the plurality of predefined object shapes or configurations; and
selecting the touch based input mode associated with the predefined object shape or configuration that the determined shape or configuration of the object is substantially similar to.

17. The method of claim 16, wherein the touch based input modes vary from one another by a sensitivity with which the input device detects touch based inputs made by the object, or by a way in which the interface system interprets the touch based input for interacting with the computing device.

18. The method of claim 16, wherein the touch based input modes comprise any one of: a typing mode, a pointer mode, a scrolling and/or panning mode, a zoom in and/or a zoom out mode, and a menu mode.

19. The method of claim 18, wherein the menu mode is one of a plurality of menu modes, each menu mode having a different input sensitivity, manner in which a touch based input is interpreted, and/or menu style.

20. The method of claim 14, wherein the method comprises the steps of:
providing information that is indicative of a predefined movement profile;
using the positional information to determine a movement of the object;
comparing the determined movement of the object to the predefined movement profile;
determining whether the movement of the object is substantially similar to the predefined movement profile; and
selecting a touch based input mode in response to determining that the movement of the object is substantially similar to the predefined movement profile.
